(19) United States
(12) Patent Application Publication
(10) Pub. No.: US 2016/0237885 A1
(43) Pub. Date: Aug. 18, 2016

(54) SUPERCHARGER HAVING PRE-BOOSTING CONFIGURATION

(71) Applicant: Eaton Corporation, Cleveland, MI (US)

(72) Inventors: Matthew J. Fortini, Allen Park, MI (US); Thomas J. Walsh, Marshall, MI (US); Bryn T. Dixon, Royal Oak, MI (US); Michael E. Coates, Marshall, MI (US)

(21) Appl. No.: 15/140,877

(22) Filed: Apr. 28, 2016

Related U.S. Application Data
(63) Continuation of application No. PCT/US2014/058779, filed on Oct. 2, 2014.
(60) Provisional application No. 61/896,731, filed on Oct. 29, 2013.

(51) Int. Cl. F02B 39/10; F04C 18/12; F04C 29/00; F02B 33/38

(52) U.S. Cl. CPC F02B 39/10; F02B 33/38; F04C 18/126; F04C 29/0085; F04C 29/005

(57) ABSTRACT

A supercharger constructed in accordance to one example of the present disclosure can include a shaft portion connected to a pulley. A pair of supercharger rotors can be arranged for concurrent rotation with respective rotor shafts. A clutch rotor can be mounted to the shaft portion. The clutch rotor can rotate around a longitudinal axis. A clutch armature can be mounted to a drive shaft and unconnected to the shaft portion. The clutch armature can be configured to rotate around the longitudinal axis. The clutch rotor and the clutch armature can selectively cooperate in an engaged position and a disengaged position. In the engaged position, the clutch rotor and the clutch armature rotate together. An electric motor can have an output that provides a rotational input to one of the rotor shafts.

### CROSS-REFERENCE TO RELATED APPLICATIONS

This application is a continuation of International Application No. PCT/US2014/058779 filed on Oct. 2, 2014, which claims the benefit of U.S. patent application Ser. No. 61/896,731 filed on Oct. 29, 2013 and U.S. patent application Ser. No. 61/932,440 filed on Jan. 28, 2014. The disclosures of the above applications are incorporated herein by reference.

### FIELD

The present disclosure relates generally to superchargers and more particularly to a clutched supercharger having an electric motor providing a driving input to a rotor shaft of the supercharger.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, are driven by meshed timing gears which are potentially subject to conditions such as gear rattle and bounce. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine.

A conventional supercharger is generally mechanically driven by the engine, and therefore, may represent a drain on engine horsepower whenever engine “boost” may not be required and/or desired. An engageable/disengageable clutch may be disposed in series between the supercharger input (e.g., a belt driven pulley) and the rotors of the supercharger. In some examples, a clutched configuration may create undesirable stick-slip conditions.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure can include a shaft portion connected to a pulley. A pair of supercharger rotors can be arranged for concurrent rotation with respective rotor shafts. A clutch rotor can be mounted to the shaft portion. The clutch rotor can rotate around a longitudinal axis. A clutch armature can be mounted to a drive shaft and unconnected to the shaft portion. The clutch armature can be configured to rotate around the longitudinal axis. The clutch rotor and the clutch armature can selectively cooperate in an engaged position and a disengaged position. In the engaged position, the clutch rotor and the clutch armature rotate together. An electric motor can have an output that provides a rotational input to one of the rotor shafts.

According to additional features, the electric motor can be mounted to a housing of the supercharger. The output of the electric motor can comprise an electric motor output shaft. The electric motor output shaft can rotate around a first axis. The rotor shaft can rotate around a second axis. The first and second axes can be collinear. The electric motor can rotate the supercharger rotors at substantially one-third of peak engagement speed. The electric motor can be configured to rotate the supercharger rotors prior to engagement of the clutch rotor and the clutch armature thereby reducing an initial speed differential between the clutch rotor and the clutch armature.

According to other features, the supercharger can further include a clutch coil that is spaced along the longitudinal axis from the pulley. The clutch rotor can be magnetized by the clutch coil. The supercharger can further comprise a clutch housing. The clutch coil can be mounted in the clutch rotor and be disposed between the clutch housing and the clutch rotor in a direction along the longitudinal axis. The electric motor can be configured to provide a constant rotational input to the supercharger rotors when the first shaft portion is being rotated.

A supercharger constructed in accordance to additional features of the present disclosure can include a first shaft portion connected to a pulley and configured to rotate around a longitudinal axis. A pair of rotors can each have a plurality of meshed lobes. A drive shaft can drive the pair of rotors. A clutch assembly can selectively couple the first shaft portion and the drive shaft between a disengaged position and an engaged position. An electric motor can drive the pair of rotors and be configured to reduce a speed differential between the first shaft portion and the drive shaft upon movement from the disengaged position to the engaged position.

According to other features, the clutch assembly can further include a clutch rotor and a clutch armature. The clutch rotor can be mounted to the first shaft portion, wherein the clutch rotor rotates around the longitudinal axis. A clutch armature can be mounted to a drive shaft and be unconnected to the first shaft portion in the disengaged position. The clutch armature can be configured to rotate around the longitudinal axis. The clutch rotor and the clutch armature can selectively cooperate in the engaged position and the disengaged position. In the engaged position, the clutch rotor and the clutch armature rotate together.

According to additional features, the supercharger can include a clutch coil spaced along the longitudinal axis from the pulley. The clutch rotor can be magnetized by the clutch coil. The supercharger can further include a clutch housing. The clutch coil is mounted in the clutch rotor and is disposed between the clutch housing and the clutch rotor in a direction along the longitudinal axis.

According to other features, the electric motor can be mounted to a housing of the supercharger. The electric motor can have an output comprising an electric motor output shaft. The electric motor output shaft can rotate around a first axis. One of the rotors can comprise a rotor shaft that rotates around the second axis. The first and second axes are collinear. The electric motor can rotate the supercharger rotors at substantially one-third of peak engagement speed. The electric motor can be configured to rotate the supercharger rotors prior to engagement of the clutch rotor and the clutch armature thereby reducing an initial speed differential between the clutch rotor and the clutch armature.

A supercharger constructed in accordance to another example of the present disclosure can include a first shaft portion connected to a pulley and configured to rotate around a longitudinal axis. A pair of supercharger rotors can each have a plurality of meshed lobes and each configured for concurrent rotation with a respective rotor shaft. A drive shaft can drive the pair of rotors. A clutch assembly can selectively couple the first shaft portion and the drive shaft between a disengaged position and an engaged position. The clutch assembly can include a clutch rotor and a clutch armature. The clutch rotor can be mounted to the first shaft portion. The clutch rotor can rotate around the longitudinal axis. The clutch armature can be mounted to a drive shaft and be unconnected to the first shaft portion in the disengaged position. The clutch armature can be configured to rotate around the longitudinal axis. The clutch rotor and the clutch armature can selectively cooperate in the engaged position and the disengaged position. In the engaged position, the clutch rotor and the clutch armature rotate together. An electric motor can drive the pair of supercharger rotors and be configured to reduce a speed differential between the first shaft portion and the drive shaft upon movement from the disengaged position to the engaged position. The electric motor can be configured to rotate the supercharger rotors prior to engagement of the clutch rotor and the clutch armature thereby reducing an initial speed differential between the clutch rotor and the clutch armature.

### BRIEF DESCRIPTION OF THE DRAWINGS

The present disclosure will become more fully understood from the detailed description and the accompanying drawings, wherein:

FIG. 1 is a cross-sectional view of an exemplary supercharger incorporating a clutch assembly and electric motor constructed in accordance to one example of the present disclosure;

FIG. 2 is an exploded perspective view of a clutch armature, clutch rotor, and clutch coil of a clutch assembly in accordance with one example of the present disclosure;

FIG. 3 is an exploded perspective view of a portion of the clutch assembly in accordance with one example of the present disclosure;

FIG. 4 is a cross-sectional view of an exemplary supercharger incorporating a clutch assembly and electric motor constructed in accordance to another example of the present disclosure;

FIG. 5 is a cross-sectional view of an exemplary supercharger incorporating a clutch assembly and electric motor constructed in accordance to another example of the present disclosure;

FIG. 6 is a cross-sectional view of an exemplary supercharger incorporating a clutch assembly and electric motor constructed in accordance to another example of the present disclosure; and

FIG. 7 is a cross-sectional view of an exemplary supercharger incorporating a clutch assembly and electric motor constructed in accordance to another example of the present disclosure.

### DETAILED DESCRIPTION

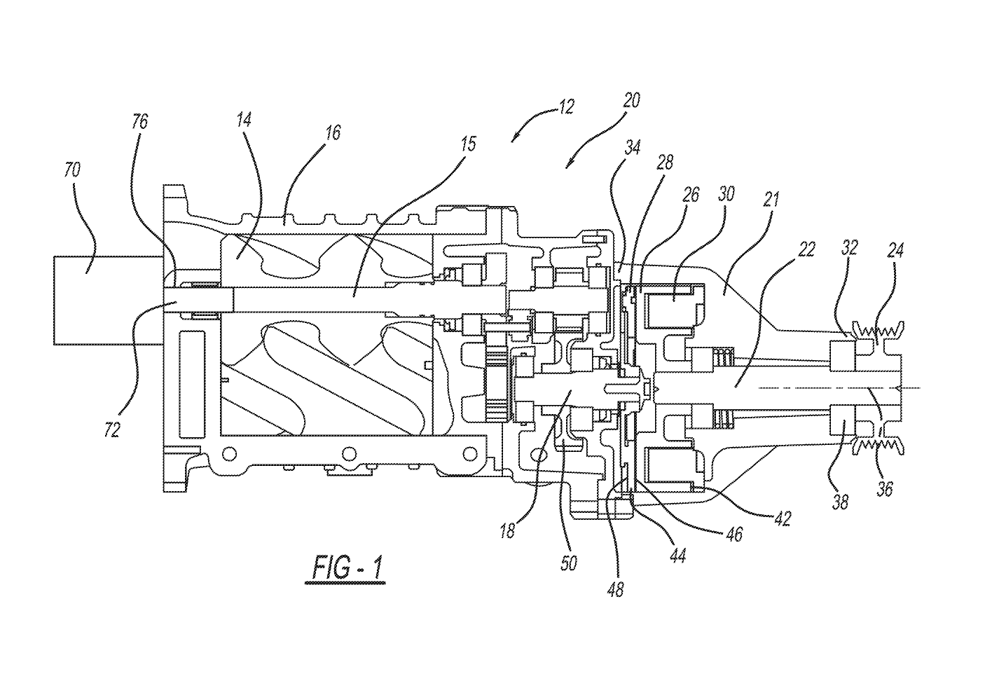

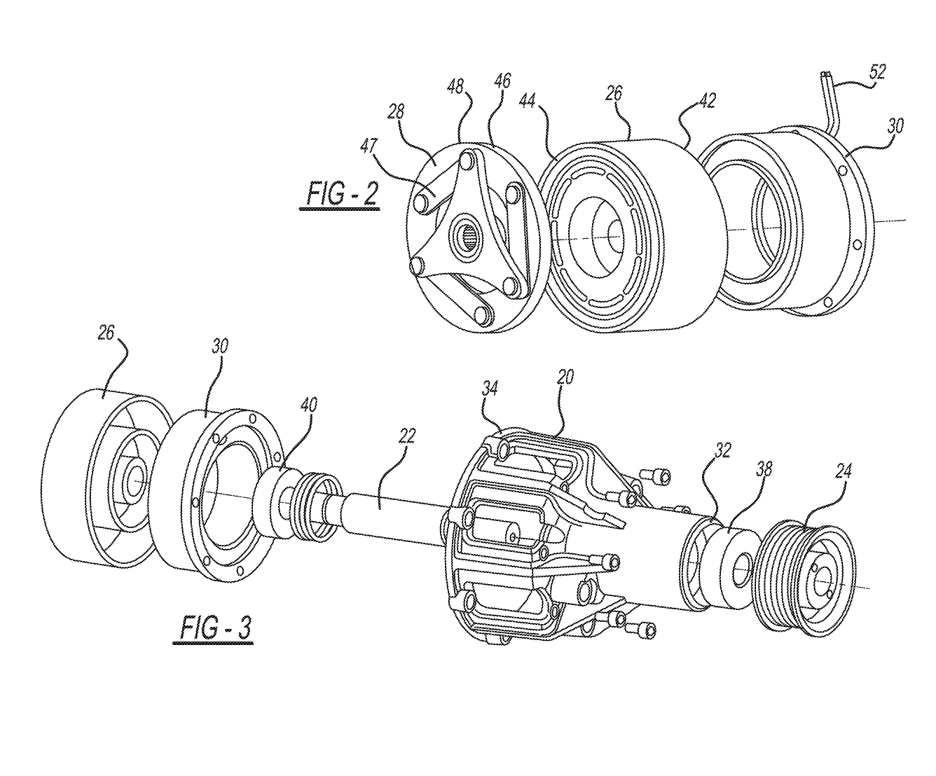

With reference to FIGS. 1-3, a supercharger constructed in accordance with one example of the present disclosure is shown and generally identified at reference 12. The supercharger 12 may be part of an intake manifold assembly for an engine (not shown). The engine may include a plurality of cylinders and a reciprocating piston disposed within each cylinder, thereby defining an expandable combustion chamber. The engine may include intake and exhaust manifold assemblies for directing combustion fluid to and from the combustion chamber by way of intake and exhaust valves, respectively.

The supercharger 12 of the intake manifold may be any positive displacement pump, including the Roots type blower supercharger illustrated and described in U.S. Pat. Nos. 5,078,583 and 5,893,355 which are owned by the assignee of the present invention and which are hereby incorporated by reference in their entirety, but are not necessarily limited thereto. The supercharger 12 may also comprise a screw compressor or any other type of positive displacement pump. In accordance with an embodiment of the invention, the supercharger 12 may include a pair of rotors 14, each having a plurality of meshed lobes. The rotors 14 each have rotor shafts 15 and may be disposed in a plurality of parallel, transversely overlapping cylindrical chambers and may be driven by engine crankshaft torque transmitted thereto in a known manner such as a drive belt. The supercharger 12 may include a main housing 16 that may define the plurality of cylindrical chambers. The mechanical drive of the supercharger 12, including a drive shaft 18, may rotate the rotors 14 at a fixed ratio, relative to the crankshaft speed, such that the displacement of the supercharger 12 is greater that the engine displacement, thereby boosting or supercharging the air flowing into the combustion chamber of the engine. The supercharger 12 may include an inlet port configured to receive fluid from an inlet duct or passage and an outlet port configured to direct the charged air to the intake valves via a discharge duct. The inlet duct or passage and the discharge duct may be interconnected by means of a bypass passage. A bypass valve may be disposed within the bypass passage and may be configured to be moved between an open position and a closed position by means of an actuator assembly.

The supercharger 12 can include a clutch assembly 20 having a clutch housing 21, a shaft portion 22, a pulley 24, a clutch rotor 26, a clutch armature 28, and a clutch coil 30. The clutch housing 21 may be configured to house other components of the clutch assembly 20. The clutch housing 21 may be smaller in diameter at a first end 32 and larger in diameter at a second end 34. The first end 32 may be proximate to the pulley 24. The second end 34 may be proximate to the main housing 16 of the supercharger 12.

The shaft 22 can rotate about a longitudinal axis 36. In the example shown, the shaft 22 is supported by a first bearing 38 and a second bearing 40. Other configurations are contemplated. The pulley 24 may be configured to transmit torque from the engine crankshaft (not shown) to the shaft 22 during engagement of the clutch assembly 20. In the example shown, the pulley 24 can be coupled to the shaft 22. In this regard, the pulley 24 can be disposed externally to the shaft 22 in accordance with one example of the present disclosure. The pulley 24 can be disposed at an end of the shaft 22 and may circumferentially surround the shaft 22. The pulley 24 can be external to the clutch housing 21. In addition, the pulley 24 can be axially spaced along the longitudinal axis 36 from the clutch housing 21. The first bearing 38 that is disposed between the clutch housing 21 and the shaft 22 may be proximate to the pulley 22. The second bearing 40 may be disposed between the clutch housing 21 and the shaft 22 closer toward the main housing 16 of the supercharger 12. The pulley 24 may be separated from other components of the clutch assembly 20. For example the pulley 24 may be separated from the clutch armature 28.

The pulley 24 may have a diameter that is independent of the diameters of the clutch rotor 26, the clutch armature 28, and the clutch coil 30. The pulley 24, including its design and configuration, is independent of the torque capacity of the clutch rotor 26, the clutch armature 28, and the clutch coil 30. In accordance with a certain torque capacity of the supercharger 12, the pulley 24 may have a diameter that is less than about 85 mm in accordance with an example of the present disclosure. The pulley 24 may have a diameter that is between about 45 mm and about 85 mm in accordance with one example of the present disclosure. Based on the diameter of the pulley 24, the pulley 24 may conventionally be considered a small pulley. The pulley 24 may have a diameter that is smaller than the diameter of the clutch coil 30 in accordance with an example of the present disclosure, as the pulley 24 may not surround the clutch coil 30 in accordance to one configuration. The pulley 24 may also not be integrated with the clutch rotor 26 in accordance with an example of the present disclosure.

The clutch rotor 26 may be configured to be magnetized and set up a magnetic loop that attracts the clutch armature 28. The clutch rotor 26 may be connected to the second shaft portion 22B and or the pulley 24. The clutch rotor 26 may rotate around the longitudinal axis 36 of the shaft 22. The clutch rotor 26 is not connected to the drive shaft 18 of the supercharger as may be conventional in small pulley designs. The clutch rotor 26 may comprise steel in one configuration. The clutch rotor 26 can be formed of other materials. The clutch rotor 26 may rotate at rotational speeds that are at least the same as the pulley 24 and may rotate at rotational speeds greater than those capable by the clutch armature 28 in an example of the present disclosure. Because the clutch rotor 26 may be connected to the shaft 22 and/or the pulley 24, the clutch rotor 26 may always maintain the same rotational speed as the pulley 24 in accordance to one configuration of the present disclosure. In this regard, the clutch rotor 26 may rotate at a rotational speed that is substantially the same as the rotational speed of the shaft 22 even with the clutch assembly 20 is disengaged. The clutch rotor 26 may generally be more stable at higher speeds than the clutch armature 28. The clutch rotor 26 may be disposed between the clutch armature 28 and the clutch coil 30 along the longitudinal axis 36. The clutch rotor 26 may have a first face 42 that is configured to at least partially surround the clutch coil 30. The clutch rotor 26 may have a second face 44 (i.e., opposing the first face 42) that is configured to face the clutch armature 28.

The clutch armature 28 can rotate around the longitudinal axis 36. The clutch armature 28 can be configured to be pulled against the clutch rotor 26 and apply a frictional force at contact. The load of the clutch armature 28 may thus be accelerated to match the rotational speed of the clutch rotor 26. The clutch armature 28 may be disposed adjacent to the clutch rotor 26 along the longitudinal axis 26. The clutch armature 28 may have a first face 46 that is configured to face the second face 44 of the clutch rotor 26 and may include a frictional material. The clutch armature 28 may have a second face 48 that is configured to face the supercharger 12. The second face 48 can oppose the first face 46.

The clutch armature 28 may be connected to the drive shaft 18 of the supercharger 12 through a spline and bolt. The clutch armature 28 may contain speed sensitive components in one example. The rotational speed of the clutch armature 28 may be less than the rotational speed of the shaft 22 when the clutch assembly 20 is disengaged. Accordingly, the clutch armature 28 may be configured to coast down to a stop when the clutch assembly 20 is disengaged, rather than always having to maintain the same rotational speed of the pulley 24.

The clutch armature 28 may not be connected to the shaft 22 and or the pulley 24 in one configuration. Instead, the clutch armature 28 may be separated from the pulley 24 in accordance with one example. The clutch armature 20 may be connected to the drive shaft 18 of the supercharger 12. The rotational speed of the clutch armature 28 may be substantially the same as the rotational speed of the shaft 22 when the clutch assembly 20 is engaged. Because it may be more difficult to keep the clutch armature 28 stable at higher speeds because of the inclusion of speed sensitive material, the clutch armature 28 may not be connected to shaft 22 and/or the pulley 24. The clutch armature 28 may be separated from the pulley 24, and therefore, the clutch armature 28 may not influence the size and/or range of the pulley 24. By separating the clutch armature 28 from the pulley 24, the size of the clutch housing 21 in the area around the pulley 24 may be decreased. Furthermore, the size and configuration of the pulley 24 may not depend on the size and/or torque capacity of the armature 28.

The clutch coil 30 can include a source of magnetic flux. An electrical current and/or voltage may be applied to the clutch coil 30 to generate a magnetic field in the vicinity of the clutch coil 30 and produce magnetic lines of flux. The intensity of the magnetic field may be proportional to the level of the current provided. This flux may then be transferred through the small working air gap between the clutch coil 30 and the clutch rotor 26. The clutch rotor 26 may thus become magnetized and set up a magnetic loop that attracts the clutch armature 28. The clutch armature 28 may then be pulled against the clutch rotor 26 and a frictional force may be applied at contact and the load on the clutch armature 28 may be accelerated to match the speed of the clutch rotor 26. When current and/or voltage is removed from the clutch assembly 20, the clutch armature 28 may be free to turn with the drive shaft 18 of the supercharger 12.

The clutch coil 30 may not be surrounded by the pulley 24. Instead, the clutch coil 30 may be mounted in the clutch rotor 26 and may be located closer to the housing 16 of the supercharger 12. The clutch coil 30 may be disposed between the clutch rotor 26 and the clutch housing 21 in a direction along the longitudinal axis 36. The clutch coil 30 may be spaced along the longitudinal axis 36 from the pulley 24. The clutch coil 30 may be separated from the pulley 24, and therefore, the clutch coil 30 may not influence the size and/or range of the pulley 24. By separating the clutch coil 30 from the pulley 24, the size of the clutch housing 21 in the area around the pulley 24 may be decreased. Furthermore, the size and configuration of the pulley 24 may not depend on the size and/or torque capacity of the clutch coil 30.

In one configuration, the clutch coil 30 may be controlled by an electronic control unit (ECU) not shown that provides an electrical signal to the clutch coil 30 via wires 52. The ECU may process input, such as for example, but not limited to, sensor readings corresponding to vehicle parameters and process the input according to log rules to determine the appropriate electrical signal to provide to the clutch coil 30. The ECU may comprise a microprocessor having sufficient memory to store the logic rules (e.g., in the form of a computer program) for controlling operation of the clutch assembly 20.

A supercharger 12 including the clutch assembly 20 in accordance to one example may further include a step-up gear 50 connected to the drive shaft 18 of the supercharger 12. Accordingly, at least one of the rotors 14 of the supercharger 12 may utilize an input drive configuration including for example the drive shaft 18 and the step up gear 50 by means of which the supercharger 12 may receive input drive torque. A supercharger 12 in accordance with one example of the present disclosure may comprise the clutch assembly 20, pair of rotors 14, housing 16 that houses the pair of rotors 14, drive shaft 18 configured to drive rotation of the pair of rotors 14 and step-up gear 50 connected to the drive shaft 18.

The supercharger 12 according to the present disclosure can incorporate an electric motor 70. In this regard, the electric motor 70 can have an electric motor output shaft 72 that connects to and provides a driving rotational input to the rotor shaft 15. In other examples, the output shaft of the electric motor 70 can be a common shaft to the rotor shaft 15. In still other examples, one or more intermediate gears may be provided between the electric motor output shaft 72 and the rotor shaft 15. In the example shown, at least one of the rotor shaft 15 and the electric motor output shaft 72 can extend through an opening 76 in the housing 16 of the supercharger 12. In one example, the electric motor 70 can be coupled to the supercharger 12 such as by fasteners engaged to the housing 16. While the particular example described herein is directed to superchargers having downstream throttles, other applications are contemplated.

The electric motor 70 can operate to rotate the rotor shaft 15 and therefore the rotors 14 to a predetermined speed. In this regard, the electric motor 70 can provide a pre-boosting configuration to the supercharger 12. In one configuration, the electric motor shaft 72 and the rotor shaft 15 can be collinear such that they rotate around a common axis. Other configurations are contemplated. In one example, the electric motor 70 can reduce or eliminate low speed clutch engagements. Explained further, the electric motor 70 can rotate the supercharger rotors 14 to a predetermined speed causing the clutch armature 28 to be rotating (rather than static) when the clutch assembly 20 is initially engaged. In this regard, the speed differential between the clutch rotor 26 (rotating with the shaft 22) and the clutch armature 28 can be reduced at initial engagement of the clutch assembly 20. According to one configuration, the electric motor 70 can rotate the rotors 14 at around one-third of peak engagement speed. In one configuration, the electric motor 70 can be configured to provide a constant rotational input to the shaft 15 when the pulley 24 is being rotated. Other configurations are contemplated.

The electric motor 70 can be powered by the vehicles electrical system. A number of advantages can be realized with the electric motor 70. For example, undesirable conditions such as stick-slip can be limited. Because a speed differential between the clutch rotor 26 and the clutch armature 28 is reduced at initial clutch engagement, less wear is realized between the clutch rotor 26 and the clutch armature 28. In this regard, clutch life and clutch control can be increased. Furthermore, for similar reasons, clutch noise can be reduced.

While the particular example shown includes an electric motor 70 having an electric motor output shaft 72 that couples mechanically to the rotor shaft 15, other configurations are contemplated. For example, other hysteresis or non-contact methods may be implemented for communicating a rotational input from an electric motor to rotational movement of the supercharger rotors 14. In one example, a non-contact magnetic coupling may be incorporated. Other configurations are contemplated.

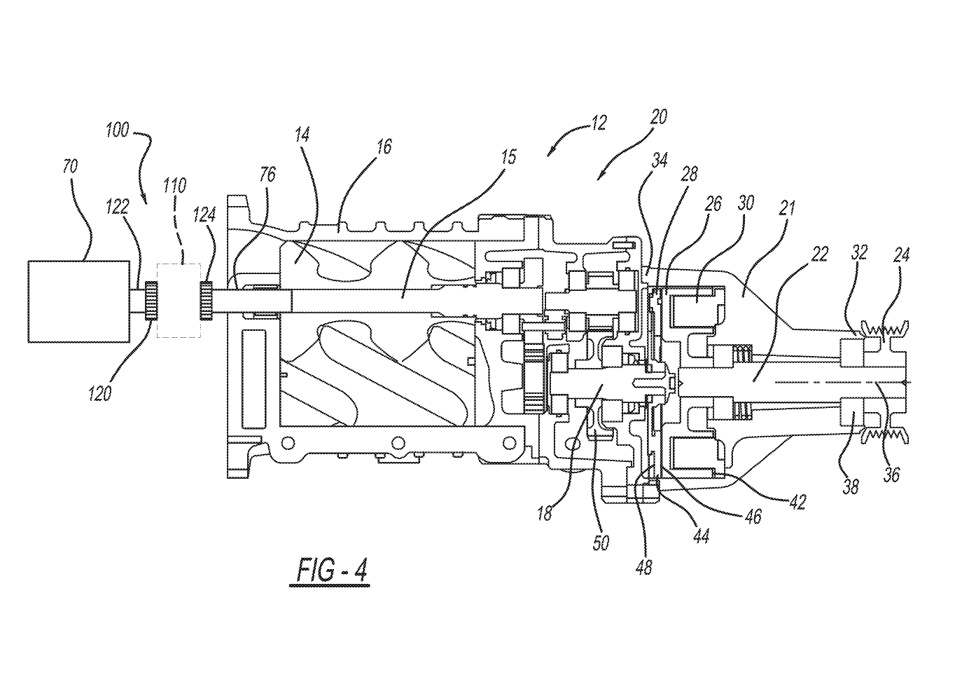

Turning now to FIG. 4, the electric motor 70 is shown coupled to the supercharger 12 according to additional features. The electric motor 70 can include an output gear 120 disposed on an output shaft 122. The rotor shaft 15 can extend through an opening 76 in the housing 16 of the supercharger. The rotor shaft 15 can include a gear 124 disposed thereon. A power transfer mechanism 110 can be disposed between the output gear 120 of the electric motor 70 and the gear 124 on the rotor shaft 15. The power transfer mechanism 110 can include a gearing configuration, a pulley or other configuration for transferring a rotory output of the electric motor output shaft 122 to a rotory input of the rotor shaft 15. Other configurations are contemplated.

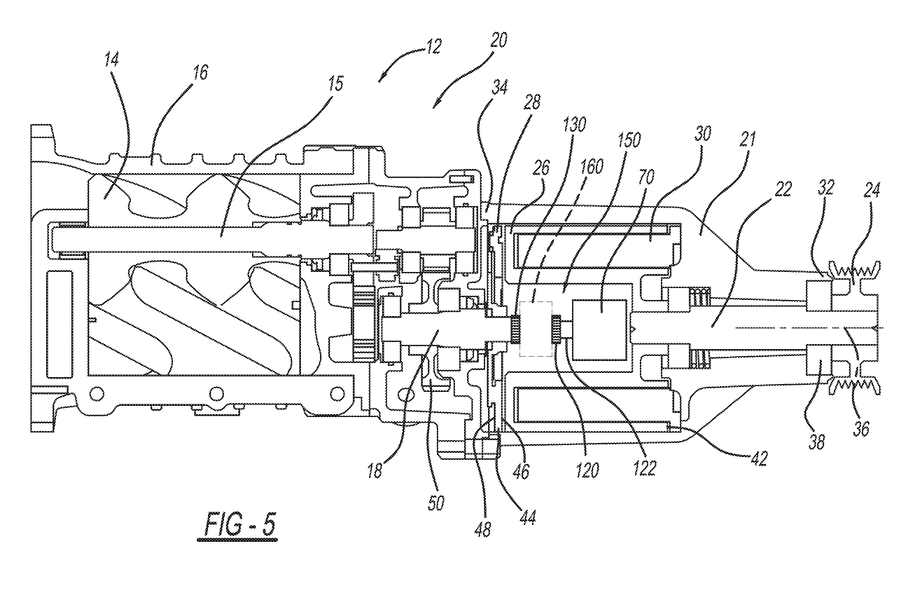

With reference to FIG. 5, the electric motor 70 is shown coupled to the supercharger 12 according to additional features. The electric motor 70 can include the output gear 120 disposed on the output shaft 122. The drive shaft 18 can have a gear 130 disposed thereon. A power transfer mechanism 160 can be disposed between the output gear 120 of the electric motor 70 and the gear 130 on the drive shaft 18. The power transfer mechanism 160 can include a gearing configuration, a pulley or other configuration for transferring a rotory output of the electric motor output shaft 122 to the gear 130 of the drive shaft 18. Other configurations are contemplated.

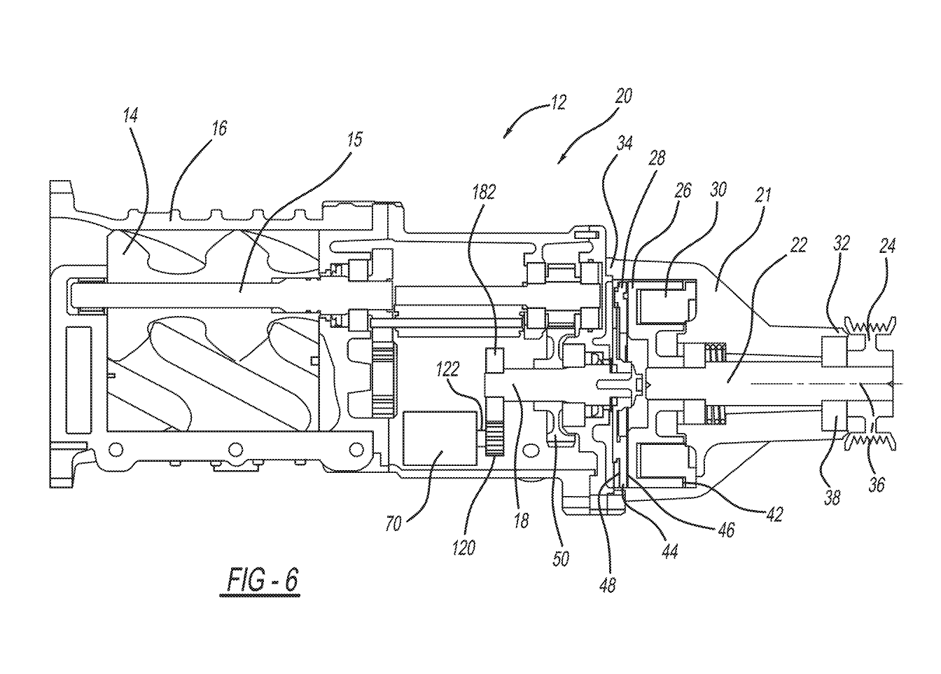

With reference to FIG. 6, the electric motor 70 is shown coupled to the supercharger 12 according to additional features. The electric motor 70 can include the output gear 120 disposed on the output shaft 122. The drive shaft 18 can have a gear 182 disposed thereon. The output gear 120 can be splined to the gear 182 for transfering a rotory output of the electric motor output shaft 122 to the drive shaft 18. It will be appreciated that an intermediate gear or transfer mechanism may be configured between the output gear 120 and the gear 182. Other configurations are contemplated.

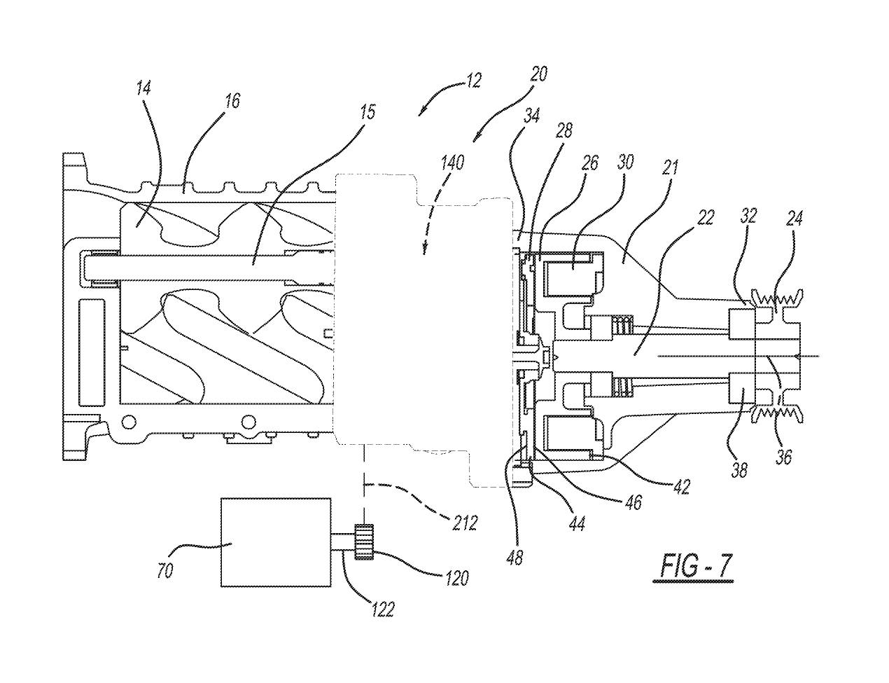

With reference to FIG. 7, the electric motor 70 is shown coupled to the supercharger 12 according to additional features. The electric motor 70 can include the output gear 120 disposed on the output shaft 122. The output gear 120 can be coupled to any internal gearing generally identified at 190 of the supercharger 12. A power transfer device 212 may be coupled between the output gear 120 and the internal gearing 190. In this regard, the electric motor 70 can be arranged to couple directly or indirectly to any rotating component of the supercharger 12. Other configurations are contemplated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a shaft portion connected to a pulley;
a pair of supercharger rotors arranged for concurrent rotation with respective rotor shafts;
a clutch rotor mounted to the shaft portion, wherein the clutch rotor rotates around a longitudinal axis;
a clutch armature mounted to a drive shaft and unconnected to the shaft portion, the clutch armature configured to rotate around the longitudinal axis, wherein the clutch rotor and clutch armature selectively cooperate in an engaged position and a disengaged position, wherein in the engaged position the clutch rotor and the clutch armature rotate together; and
an electric motor having an output that provides a rotational input to one of the rotor shafts.

2. The supercharger of claim 1 wherein the electric motor is mounted to a housing of the supercharger.

3. The supercharger of claim 2 wherein the output of the electric motor comprises an electric motor output shaft.

4. The supercharger of claim 3 wherein the electric motor output shaft rotates around a first axis and wherein the one of the rotor shafts rotates around a second axis, wherein the first and second axes are collinear.

5. The supercharger of claim 1 wherein the electric motor rotates the supercharger rotors at substantially one-third of peak engagement speed.

6. The supercharger of claim 1 wherein the electric motor is configured to rotate the supercharger rotors prior to engagement of the clutch rotor and the clutch armature thereby reducing an initial speed differential between the clutch rotor and the clutch armature.

7. The supercharger of claim 1, further comprising:
a clutch coil spaced along the longitudinal axis from the pulley wherein the clutch rotor is magnetized by the clutch coil.

8. The supercharger of claim 7, further comprising a clutch housing, wherein the clutch coil is mounted in the clutch rotor and is disposed between the clutch housing and the clutch rotor in a direction along the longitudinal axis.

9. The supercharger of claim 1 wherein the electric motor is configured to provide a constant rotational input to the supercharger rotors when the first shaft portion is being rotated.

10. A supercharger comprising:
a first shaft portion connected to a pulley and configured to rotate around a longitudinal axis;
a pair of rotors each having a plurality of meshed lobes;
a drive shaft that drives the pair of rotors;
a clutch assembly that selectively couples the first shaft portion and the drive shaft between a disengaged position and an engaged position; and
an electric motor that drives the pair of rotors and is configured to reduce a speed differential between the first shaft portion and the drive shaft upon movement from the disengaged position to the engaged position.

11. The supercharger of claim 10 wherein the clutch assembly further comprises:
a clutch rotor mounted to the first shaft portion, wherein the clutch rotor rotates around the longitudinal axis; and
a clutch armature mounted to a drive shaft and unconnected to the first shaft portion in the disengaged position, the clutch armature configured to rotate around the longitudinal axis, wherein the clutch rotor and clutch armature selectively cooperate in the engaged position and the disengaged position, wherein in the engaged position the clutch rotor and the clutch armature rotate together.

12. The supercharger of claim 11, further comprising:
a clutch coil spaced along the longitudinal axis from the pulley wherein the clutch rotor is magnetized by the clutch coil.

13. The supercharger of claim 12, further comprising a clutch housing, wherein the clutch coil is mounted in the clutch rotor and is disposed between the clutch housing and the clutch rotor in a direction along the longitudinal axis.

14. The supercharger of claim 10 wherein the electric motor is mounted to a housing of the supercharger.

15. The supercharger of claim 14 wherein the electric motor has an output comprising an electric motor output shaft.

16. The supercharger of claim 15 wherein the electric motor output shaft rotates around a first axis and wherein one of the rotors comprises a rotor shaft that rotates around a second axis, wherein the first and second axes are collinear.

17. The supercharger of claim 10 wherein the electric motor rotates the supercharger rotors at substantially one-third of peak engagement speed.

18. The supercharger of claim 10 wherein the electric motor is configured to rotate the supercharger rotors prior to engagement of the clutch rotor and the clutch armature thereby reducing an initial speed differential between the clutch rotor and the clutch armature.

19. A supercharger comprising:
a first shaft portion connected to a pulley and configured to rotate around a longitudinal axis;
a pair of supercharger rotors each having a plurality of meshed lobes and each configured for concurrent rotation with a respective rotor shaft;
a drive shaft that drives the pair of rotors;
a clutch assembly that selectively couples the first shaft portion and the drive shaft between a disengaged position and an engaged position, the clutch assembly comprising;
a clutch rotor mounted to the first shaft portion, wherein the clutch rotor rotates around the longitudinal axis; and
a clutch armature mounted to a drive shaft and unconnected to the first shaft portion in the disengaged position, the clutch armature configured to rotate around the longitudinal axis, wherein the clutch rotor and clutch armature selectively cooperate in the engaged position and the disengaged position, wherein in the engaged position the clutch rotor and the clutch armature rotate together; and
an electric motor that drives the pair of supercharger rotors and is configured to reduce a speed differential between the first shaft portion and the drive shaft upon movement from the disengaged position to the engaged position.

20. The supercharger of claim 19 wherein the electric motor is configured to rotate the supercharger rotors prior to engagement of the clutch rotor and the clutch armature thereby reducing an initial speed differential between the clutch rotor and the clutch armature.

21. The supercharger of claim 18, further comprising one of a pulley and gear arrangement disposed intermediate an electric motor output shaft of the electric motor and the rotor shaft.

22. The supercharger of claim 18 wherein the electric motor provides an input to the drive shaft.

23. The supercharger of claim 22, further comprising a power transfer device disposed intermediate the electric motor and the drive shaft.
